(19) United States
(12) Patent Application Publication
(10) Pub. No.: US 2025/0077207 A1
(43) Pub. Date: Mar. 6, 2025

(54) SYSTEM DEPLOYMENT METHOD, ELECTRONIC DEVICE, AND STORAGE MEDIUM

(71) Applicant: New H3C Information Technologies Co., Ltd., Hangzhou (CN)

(72) Inventor: Yinting YU, Beijing (CN)

(21) Appl. No.: 18/821,491

(22) Filed: Aug. 30, 2024

(30) Foreign Application Priority Data
Sep. 6, 2023 (CN) 202311149179.2

(51) Int. Cl. G06F 8/61

(52) U.S. Cl. CPC G06F 8/61

(57) ABSTRACT

The present disclosure provides a system deployment method, an electronic device, and machine-readable storage medium. The method comprises: configuring shared memory for the CXL server in response to a shared memory configuration request from the CXL server; generating a shared memory mapping table based on the configured shared memory; sending shared information to CXL terminal in response to a CXL interaction request from the CXL terminal. Through this solution, the CXL server that distributes the files to be deployed will transmit the files to be deployed into the shared memory. Several CXL terminals that can read from and write to this shared memory obtain the files stored in the shared memory in a manner similar to accessing regular memory. The terminals complete system deployment based on these files. This achieves batch system deployment without the need to transmit the files to be deployed to the terminals over the network.

### CROSS REFERENCE TO RELATED APPLICATIONS

This application claims priority to Chinese Patent Application No. 202311149179.2, filed on Sep. 6, 2023, the disclosure of which is incorporated herein by reference in its entirety for all purposes.

### TECHNICAL FIELD

The present disclosure relates to the field of wireless communication technology, and in particular to a system deployment method, an electronic device and a machine-readable storage medium.

### BACKGROUND

Calculate Express Link (CXL) is an interconnection designed for memory expansion, heterogeneous computing, and system resource decomposition. Using CXL provides efficient resource sharing and pooling, while maintaining low latency and high bandwidth through cache-coherent load-store semantics.

CXL Fabric Management (FM) is responsible for system combination and resource allocation. FM can be embedded in CXL switches, server hosts, or BMCs. FM manages apparatuses, such as Signal Logical Devices (SLD), Multi Logical Devices (MLD), switches, and pool memory controllers through the component command interface FM API. Its role here is to allocate memories from the memory pool to specific hosts.

### SUMMARY

In view of the forgoing, the present application provides a system deployment method, an electronic device and a machine-readable storage medium to improve the above problem that system deployments must rely on network transmission.

Specific technical solutions are as follows.

The present application provides a system deployment method applied to a CXL manager, where the method includes: configuring a shared memory for a CXL server in response to a shared memory configuration request from the CXL server, wherein the shared memory is for storing files to be deployed, which are written into the shared memory by the CXL server in response to an event that the CXL manager completes configuration of the shared memory for the CXL server; generating a shared memory mapping table based on the shared memory configured for the CXL server, wherein the shared memory mapping table is for maintaining the configured shared memory and recording storage addresses of the files to be deployed that have been written into the configured shared memory; sending shared information to a CXL terminal in response to a CXL interaction request from the CXL terminal, wherein the shared information comprises the storage addresses of the files to be deployed, and the shared information is for enabling the CXL terminal to obtain the files to be deployed that have been written into the shared memory based on the shared information.

The present application further provides an electronic device including: a processor and a non-transitory storage medium storing machine executable instructions, wherein by executing the machine executable instructions, the processor is caused to configure a shared memory for a CXL server in response to a shared memory configuration request from the CXL server, wherein the shared memory is for storing files to be deployed, which are written into the shared memory by the CXL server in response to an event that a CXL manager completes configuration of the shared memory for the CXL server; generate a shared memory mapping table based on the shared memory configured for the CXL server, wherein the shared memory mapping table is for maintaining the configured shared memory and recording storage addresses of the files to be deployed that have been written into the configured shared memory; send shared information to a CXL terminal in response to a CXL interaction request from the CXL terminal, wherein the shared information comprises the storage addresses of the files to be deployed, and the shared information is for enabling the CXL terminal to obtain the files to be deployed that have been written into the shared memory based on the shared information.

The present application further provides a machine-readable storage medium, where the machine-readable storage medium stores machine-executable instructions, which, when invoked and executed by a processor, cause the processor to perform the aforementioned system deployment method.

### BRIEF DESCRIPTION OF DRAWINGS

In order to more clearly illustrate the technical solutions in the embodiments of the present application or the prior art, the accompanying drawings need to be used in the description of the embodiments of the present application or the prior art will be briefly introduced in the following. It is obvious that the accompanying drawings in the following description are merely some of the embodiments recorded in the present application, and for a person of ordinary skill in the field, it is possible to obtain other accompanying drawings based on these accompanying drawings of the embodiments of the present application.

FIG. 1 is an example flowchart of a system deployment method according to the present disclosure;

FIG. 2 is an example flowchart of a system deployment method according to the present disclosure;

FIG. 3 is an example hardware structural diagram of an electronic device according to the present disclosure.

### DETAILED DESCRIPTION

The present disclosure will be described below with reference to a plurality of examples shown in the drawings. The terminology used in the present disclosure is for the purpose of describing particular examples only, and is not intended to be limiting of the present disclosure. The singular forms such as “a”, “said”, and “the” used in the present disclosure and the appended claims are further intended to include multiple, unless the context clearly indicates otherwise. It is also to be understood that the term “and/or” as used herein refers to any or all possible combinations that include one or more associated listed items.

It is to be understood that although various information may be described using the terms such as first, second, third, etc. In the present disclosure, these information should not be limited to these terms. These terms are used only to distinguish the same type of information from each other. For example, the first information may also be referred to as the second information without departing from the scope of the present disclosure, and similarly, the second information may also be referred to as the first information. Depending on the context, the word “if” as used herein may be interpreted as “when” or “as” or “determining in response to”.

The traditional way of server OS deployment, such as PXE or KVM out-of-band installation system based on the BMC, cannot bypass the transmission of an image of a system via the Ethernet network port from the remote end, and only after the transmission is completed, can start the installation of the image of the system, and requires complex environment deployment in advance.

A specific implementation is as follows.

In an example of present disclosure, a system deployment method is applied to a CXL manager. The method comprises: configuring shared memory for a CXL server in response to a shared memory configuration request from the CXL server, where the shared memory is used to store files to be deployed which are written into the shared memory by the CXL server in response to an event that the CXL manager completes the configuration of the shared memory for the CXL server; generating a shared memory mapping table based on the shared memory configured for the CXL server, where the shared memory mapping table is used to maintain the configured shared memory and record the storage addresses of the files to be deployed that have been written into the configured shared memory; sending shared information to a CXL terminal in response to a CXL interaction request from the CXL terminal, where the shared information comprises the storage addresses of the files to be deployed, enabling the CXL terminal to obtain the files to be deployed that have been written into the shared memory based on the shared information.

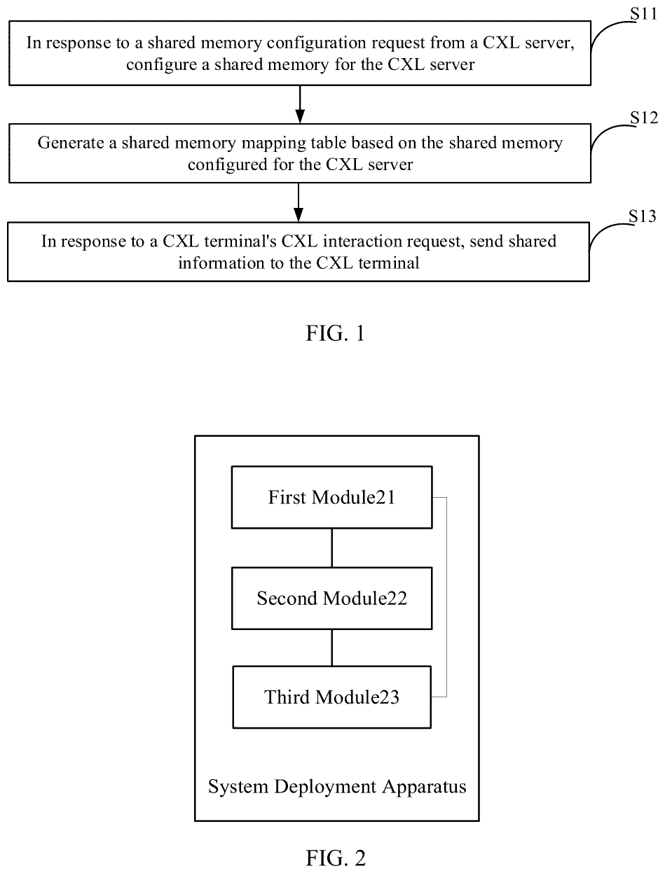

As shown in FIG. 1, this example comprises the following Steps:
Step S11: Configuring a shared memory for a CXL server in response to a shared memory configuration request from the CXL server;
Step S12: Generating a shared memory mapping table based on the shared memory configured for the CXL server;
Step S13: Sending shared information to a CXL terminal in response to a CXL interaction request from the CXL terminal.

The CXL server distributing the files to be deployed will transfer the files into the shared memory. Several CXL terminals that can read from and write to the shared memory can access these files to be deployed stored in the shared memory in the manner of memory access, and complete system deployment based on these files. This allows for batch system deployment without the need to transmit the files to be deployed to the terminals via network.

In one embodiment, the method comprises a process of: configuring shared memory for the CXL server in response to a shared memory configuration request from the CXL server, where the shared memory is used to store files to be deployed which are written into the shared memory by the CXL server in response to the event that the CXL manager completes configuration of the shared memory for the CXL server. This process comprises: configuring CXL shared memory in response to a shared memory configuration request from the CXL server; invoking a process to further configure a memory disk area in the configured CXL shared memory; storing the files to be deployed transmitted by the CXL server in the memory disk area.

Virtualizing memory as a hard disk in the shared memory, configuring a memory disk area, and storing the files to be deployed in the memory disk.

In one embodiment, generating a shared memory mapping table based on the shared memory configured for the CXL server, where the shared memory mapping table is used to maintain the configured shared memory and record the storage addresses of the files to be deployed that have been written into the configured shared memory, comprises: the memory mapping table comprises CXL shared memory base address and the storage addresses of the files to be deployed in the memory disk.

The base address of the shared memory and the storage addresses of the files to be deployed in the memory disk are recorded so that the CXL terminal can find the location of the shared memory based on the base address and load it, then obtain the files to be deployed based on their storage addresses.

In one embodiment, sending shared information to the CXL terminal in response to a CXL interaction request from the CXL terminal, where the shared information comprises the storage addresses of the files to be deployed, so as to enable the CXL terminal to obtain the files to be deployed that have been written into the shared memory based on the shared information, comprises: the shared information comprises the CXL shared memory base address and the storage addresses of the files to be deployed in the memory disk. The shared information enables the CXL terminal to recognize the memory disk through Unified Extensible Firmware Interface (UEFI) and boot, so as to deploy the system comprised in the files to be deployed.

When the files to be deployed are an image of the system to be deployed, the CXL terminal can identify the memory disk in UEFI mode and boot from the image within the memory disk, and further load and deploy the system comprised in the files to be deployed under the guidance of the boot image.

In one embodiment, the CXL terminal (CXL boot client) can recognize the addresses in the shared memory and the location of the ISO boot image, thereby booting from the shared memory and further performing the installation of the system.

If the CXL server (CXL boot Server) as Host1 has completed the shared memory configuration process via FM, Host1 will write the OS system image to the corresponding shared memory Base+ISO Mem Offset. FM's role here, besides allocating memory pool memory, is to maintain the shared memory mapping table. The mapping table maintains the memory blocks shared by CXL servers and the storage address of the ISO image. For any CXL terminal as Host2, for instance, the CXL boot client in Host2 initiates a CXL boot request (CXL interaction request). If FM finds an ISO image shared pool, it returns the memory address ISO Mem Offset of the image location. Host2 can locate the ISO image based on the shared memory base address+ISO Mem Offset returned by FM. If there is no shareable image offset area, the CXL server is required to apply for a CXL shared memory and write the ISO image from the CXL boot Server into the shared memory block while maintaining the storage position of the ISO image.

FM can run on the CXL server or as an independent apparatus.

In one example of the disclosure, a system deployment apparatus is provided and may be as shown in FIG. 2, applied to the CXL manager. The apparatus comprises: a first module, configured to configure shared memory for the CXL server in response to a shared memory configuration request from the CXL server, where the shared memory is used for storing files to be deployed, which are written into the shared memory by the CXL server in response to an event that the CXL manager completes configuration of the shared memory for the CXL server; a second module, configured to generate a shared memory mapping table based on the shared memory configured for the CXL server, where the shared memory mapping table is used to maintain the configured shared memory and record the storage addresses of the files to be deployed that have been written into the shared memory; and a third module, configured to send shared information to the CXL terminal in response to a CXL interaction request from the CXL terminal, where the shared information comprises the storage addresses of the files to be deployed. The shared information is used to enable the CXL terminal to obtain the files to be deployed that have been written into the shared memory based on the shared information.

In one embodiment, configuring the shared memory for the CXL server in response to the shared memory configuration request from the CXL server, where the shared memory is used to store files to be deployed, which are written into the shared memory by the CXL server in response to the event that the CXL manager completes configuration of the shared memory for the CXL server, comprises: configuring a CXL shared memory in response to a shared memory configuration request from the CXL server; invoking a process to further configure a memory disk area in the configured CXL shared memory; and storing the files to be deployed transmitted by the CXL server in the memory disk area.

In one embodiment, generating the shared memory mapping table based on the shared memory configured for the CXL server, where the shared memory mapping table is used to maintain the configured shared memory and record the storage addresses of the files to be deployed that have been written into the configured shared memory, comprises: the shared memory mapping table comprising a CXL shared memory base address and the storage addresses of the files to be deployed in the memory disk area.

In one implementation, in response to the CXL interaction request from the CXL terminal, sending shared information to the CXL terminal, where the shared information includes the storage address of the files to be deployed, and the shared information is used to enable the CXL terminal to obtain the files to be deployed that have been already written to the shared memory according to the shared information, includes: the shared information including the CXL shared memory base address and the storage addresses of the files to be deployed in the memory disk area, where the shared information is used to enable the CXL terminal to identify the memory disk area and boot through UEFI according to the shared information, so as to deploy a system that included in the files to be deployed.

The apparatus embodiments are the same or similar to the corresponding method embodiments and will not be repeated here.

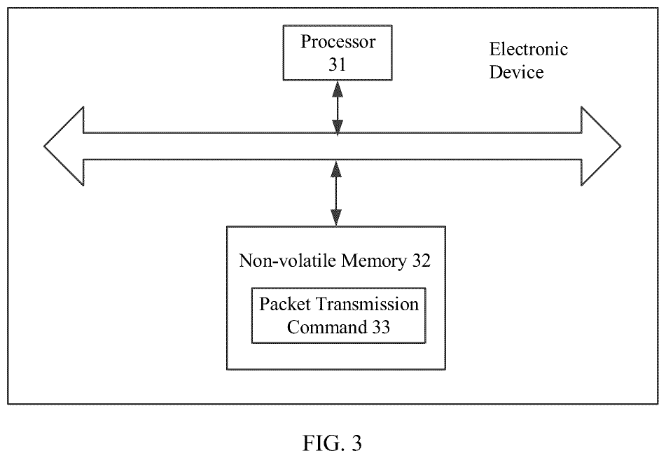

In one embodiment, the disclosure provides an electronic device including a processor (31) and a machine-readable storage medium, where the machine-readable storage medium stores machine-executable instructions that can be executed by the processor. The processor executes these machine-executable instructions to perform the aforementioned system deployment method. The hardware architecture schematic diagram can be referred to in FIG. 3.

In one embodiment, the disclosure provides a machine-readable storage medium. The machine-readable storage medium stores machine-executable instructions. When these instructions are invoked and executed by a processor, they cause the processor to perform the aforementioned system deployment method.

The CXL server distributing the files to be deployed will transfer the files to be deployed to the shared memory. Several CXL terminals with read and write accesses to the shared memory can access the files to be deployed stored in the shared memory and complete the system deployment based on the files to be deployed, thus achieving batch system deployment without the need to transfer the files to be deployed to the terminals via the network.

Here, the machine-readable storage medium can be any electronic, magnetic, optical, or other physical storage apparatus that can contain or store information, e.g. executable instructions, data, etc. For example, the machine-readable storage medium can be: a Random Access Memory (RAM), a volatile memory, a non-volatile memory, a flash memory, storage drives, e.g. a hard disk drive, a solid-state drive, any type of storage disk e.g. CDs, DVDs, or a similar storage media, or their combination.

The systems, apparatus, modules, or units described in the above embodiments can be implemented by computer chips or entities or by products with certain functions. A typical implementation apparatus is a computer, and the specific form of the computer can be a personal computer, a laptop, a cellular phone, a camera phone, a smartphone, a personal digital assistant, a media player, a navigation apparatus, an email receiving and sending apparatus, a game console, a tablet computer, a wearable apparatus or a combination of several of these apparatuses.

For ease of description, the above apparatus are described by dividing functions into modules. It should be understood that the functions of the various units can be realized in the same or multiple softwares and/or hardwares while implementing this disclosure.

Those skilled in the art should understand that the embodiments of this disclosure can be made available as methods, systems, or computer program products. Therefore, this disclosure can be implemented as any combination of hardware and software. Additionally, this disclosure can be implemented as a computer program product applied to one or more computer-readable storage medium containing computer-readable program code, i.e., magnetic disks, CD-ROMs, optical storage medium.

This disclosure has been described in terms of methods, apparatuses (systems), and computer program products with reference to flowcharts and/or block diagrams. It should be understood that each flow or block in the flowcharts and/or block diagrams and combinations of flows or blocks can be implemented by computer program instructions. These computer program instructions can be provided to a general-purpose computer, a special-purpose computer, an embedded processor, or other programmable data processing apparatuses to produce a machine, such that instructions executed by a computer or other programmable data processing apparatuses generate means for implementing the functions specified in one or more flows of the flowcharts and/or one or more blocks of the block diagrams.

The computer program instructions may also be stored in a computer-readable memory that can direct a computer or other programmable data processing apparatuses to function in a particular manner, such that the instructions stored in the computer-readable memory produce an article of manufacture including instruction means which implement the function specified in one or more flows of the flowcharts and/or one or more blocks of the block diagrams.

These computer program instructions can also be loaded onto a computer or other programmable data processing apparatuses to cause a series of operational steps to be performed on the computer or other programmable apparatuses to produce computer-implemented processing. Thus, the instructions that run on the computer or other programmable apparatuses provide steps for implementing the functions specified in one or more flows of the flowcharts and/or one or more blocks of the block diagrams.

Those skilled in the art should understand that the embodiments of this disclosure can be provided as methods, systems, or computer program products. Therefore, the disclosure can be implemented as a hardware, a software or any combination of hardware and software. Additionally, the disclosure can be implemented as a computer program product applied to one or more computer-readable storage medium containing computer-readable program code, which may include but is not limited to magnetic disks, CD-ROMs, optical storage medium.

The embodiments described above are merely exemplary and not meant to limit this disclosure. Those skilled in the art can make various modifications and changes to the disclosure. Any modifications, equivalent replacements, or improvements within the spirit and principle of this disclosure should be comprised within the scope of the claims of this disclosure.

What is claimed is:

1. A system deployment method, applied to a Calculate Express Link (CXL) manager, wherein the method comprises:
configuring a shared memory for a CXL server in response to a shared memory configuration request from the CXL server, wherein the shared memory is for storing files to be deployed, which are written into the shared memory by the CXL server in response to an event that the CXL manager completes configuration of the shared memory for the CXL server;
generating a shared memory mapping table based on the shared memory configured for the CXL server, wherein the shared memory mapping table is for maintaining the configured shared memory and recording storage addresses of the files to be deployed that have been written into the configured shared memory;
sending shared information to a CXL terminal in response to a CXL interaction request from the CXL terminal, wherein the shared information comprises the storage addresses of the files to be deployed, and the shared information is for enabling the CXL terminal to obtain the files to be deployed that have been written into the shared memory based on the shared information.

2. The method of claim 1, wherein configuring the shared memory for the CXL server in response to the shared memory configuration request from the CXL server, wherein the shared memory is for storing files to be deployed, which are written into the shared memory by the CXL server in response to the event that the CXL manager completes configuration of the shared memory for the CXL server, comprises:
configuring a CXL shared memory in response to a shared memory configuration request from the CXL server, invoking a process to further configure a memory disk area in the configured CXL shared memory, and storing the files to be deployed transmitted by the CXL server in the memory disk area.

3. The method of claim 2, wherein generating the shared memory mapping table based on the shared memory configured for the CXL server, wherein the shared memory mapping table is for maintaining the configured shared memory and recording the storage addresses of the files to be deployed that have been written into the configured shared memory, wherein the method further comprises:
the shared memory mapping table comprises a CXL shared memory base address and the storage addresses of the files to be deployed in the memory disk area.

4. The method of claim 3, wherein sending shared information to the CXL terminal in response to the CXL interaction request from the CXL terminal, wherein the shared information comprises the storage addresses of the files to be deployed, and the shared information is for enabling the CXL terminal to obtain the files to be deployed that have been written into the shared memory based on the shared information, comprises:
the shared information comprises the CXL shared memory base address and the storage addresses of the files to be deployed in the memory disk area, and the shared information is for enabling the CXL terminal to recognize the memory disk area through Unified Extensible Firmware Interface (UEFI) and boot, so as to deploy a system comprised in the files to be deployed.

5. An electronic device, comprising:
a processor and a non-transitory storage medium storing machine executable instructions, wherein by executing the machine executable instructions, the processor is caused to:
configure a shared memory for a Calculate Express Link (CXL) server in response to a shared memory configuration request from the CXL server, wherein the shared memory is for storing files to be deployed, which are written into the shared memory by the CXL server in response to an event that a CXL manager completes configuration of the shared memory configuration for the CXL server;
generate a shared memory mapping table based on the shared memory configured for the CXL server, wherein the shared memory mapping table is for maintaining the configured shared memory and recording storage addresses of the files to be deployed that have been written into the configured shared memory;
send shared information to a CXL terminal in response to a CXL interaction request from the CXL terminal, wherein the shared information comprises the storage addresses of the files to be deployed, and the shared information is for enabling the CXL terminal to obtain the files to be deployed that have been written into the shared memory based on the shared information.

6. The electronic device of claim 5, wherein configuring the shared memory for the CXL server in response to the shared memory configuration request from the CXL server, wherein the shared memory is for storing files to be deployed, which are written into the shared memory by the CXL server in response to the event that the CXL manager completes configuration of the shared memory for the CXL server, comprises:
configuring a CXL shared memory in response to a shared memory configuration request from the CXL server, invoking a process to further configure a memory disk area in the configured CXL shared memory, and storing the files to be deployed transmitted by the CXL server in the memory disk area.

7. The electronic device of claim 6, wherein generating the shared memory mapping table based on the shared memory configured for the CXL server, wherein the shared memory mapping table is for maintaining the configured shared memory and recording the storage addresses of the files to be deployed that have been written into the configured shared memory, comprises:
the shared memory mapping table comprises a CXL shared memory base address and the storage addresses of the files to be deployed in the memory disk area.

8. The electronic device of claim 7, wherein sending shared information to the CXL terminal in response to the CXL interaction request from the CXL terminal, wherein the shared information comprises the storage addresses of the files to be deployed, and the shared information is for enabling the CXL terminal to obtain the files to be deployed that have been written into the shared memory based on the shared information, comprises:
the shared information comprises the CXL shared memory base address and the storage addresses of the files to be deployed in the memory disk area, and the shared information is for enabling the CXL terminal to recognize the memory disk area through Unified Extensible Firmware Interface (UEFI) and boot, so as to deploy a system comprised in the files to be deployed.

9. A non-transitory machine-readable storage medium, wherein the non-transitory machine-readable storage medium stores machine-executable instructions, which, when invoked and executed by a processor, cause the processor to perform the method according to claim 1.
